(19) United States
(12) Patent Application Publication
(10) Pub. No.: US 2025/0314873 A1
(43) Pub. Date: Oct. 9, 2025

(54) EYEPIECE OPTICAL MODULE

(71) Applicant: GENIUS ELECTRO-OPTICS (XIAMEN) CO., LTD., FUJIAN (CN)

(72) Inventors: Changwei Liu, FUJIAN (CN); Haibin Zhan, FUJIAN (CN)

(73) Assignee: GENIUS ELECTRO-OPTICS (XIAMEN) CO., LTD., FUJIAN (CN)

(21) Appl. No.: 18/939,526

(22) Filed: Nov. 7, 2024

(30) Foreign Application Priority Data
Apr. 3, 2024 (CN) 202410405825.5

(51) Int. Cl. G02B 25/00; G02B 7/02; G02B 27/01

(52) U.S. Cl. CPC G02B 25/001; G02B 7/025; G02B 27/0149; G02B 2027/0152; G02B 2027/0161

(57) ABSTRACT

An eyepiece optical module includes a first housing, a second housing and a lens element disposed between the first housing and the second housing. One of the first housing and the second housing includes at least three supporting cylinders, the other includes at least three guide grooves, and only the supporting cylinders are in direct contact between the first housing and the second housing. Any one of the three supporting cylinders satisfies the following conditional expressions: 0.20≤r1/H1≤4.40 and 0.34 mm≤r1≤1.35 mm, wherein r1 is a radius of one end of the supporting cylinder and H1 is a height of the supporting cylinder.

### CROSS-REFERENCE TO RELATED APPLICATION

This application claims the priority benefit of China application serial no. 202410405825.5, filed on Apr. 3, 2024. The entirety of the above-mentioned patent application is hereby incorporated by reference herein and made a part of this specification.

### BACKGROUND

### Technical Field

The present invention relates to an optical module, and in particular to an eyepiece optical module.

### Description of Related Art

When wearing a near-eye display, the comfort of a user is largely subject to the weight and volume of the near-eye display. With the thriving development of virtual reality (VR) and augmented reality (AR) technologies, the gradually increasing number of optical elements has brought challenges for realization of lightweight and improvement of assembly yield of near-eye displays.

FIG. 1 is a schematic cross-sectional view of an eyepiece optical module in the related art. For example, the eyepiece optical module 1 includes a display element 400, a display element adhesive layer 2, a display element housing 3, a lens element housing 4, a first lens element 300A, a second lens element 300B and a screw 5. The display element 400 is connected to the display element housing 3 using the display element adhesive layer 2. The display element housing 3 and the lens element housing 4 are connected to each other using the screw 5. Since the display element housing 3 and the lens element housing 4 are large in size, and the first lens element 300A and the second lens element 300B are heavy, the screw 5 is normally used as coupling components for connecting them. However, there are minimum area and volume restrictions for the screw 5 and the locking structure of the screw 5, and the fabrication thereof is difficult. Besides, the screw also has a certain weight, and therefore material and assembly costs are also high. On the other hand, when dispensing is adopted to combine the display element housing 3 and the lens element housing 4 in order to reduce the volume, weight and cost, the dispensing adhesive often overflows into the joints of the housings or onto the first lens element 300A and the second lens element 300B, which results in low assembly yield. Therefore, how to manufacture lightweight, low-cost and high-yield eyepiece optical modules is a problem currently to be solved by practitioners of the art.

### SUMMARY

The present invention provides an eyepiece optical module, which is easy to assemble, has a lightweight device and has good assembly yield.

In an embodiment of the invention, an eyepiece optical module includes a first housing, a second housing and a lens element disposed between the first housing and the second housing. One of the first housing and the second housing includes at least three supporting cylinders, the other includes at least three guide grooves, and only the supporting cylinders are in direct contact with the guide grooves between the first housing and the second housing. Any one of the three supporting cylinders satisfies the following conditional expression: 0.20≤r1/H1≤4.40 and 0.34 mm≤r1≤1.35 mm, wherein r1 is a radius of one end of the supporting cylinder and H1 is a height of the supporting cylinder.

In another embodiment of the invention, an eyepiece optical module includes a first housing, a second housing and a lens element disposed between the first housing and the second housing. One of the first housing and the second housing includes three supporting cylinders, the other includes three guide grooves, and only three supporting cylinders are in direct contact with the three guide grooves between the first housing and the second housing. Any one of the three supporting cylinders satisfies the following conditional expression: 0.20≤r1/H1≤4.40 and 45.00≤ODh/r1≤190.00, wherein r1 is a radius of the bottom surface of one end of the supporting cylinder, H1 is a maximum height of the supporting cylinder, and ODh is a maximum outer diameter of the first housing.

Based on the above, the eyepiece optical module in the embodiments of the present invention is assembled with a supporting cylinder. The circular supporting surface facilitates mold processing, while reducing the risk of excessive local stress, and increasing the supporting area for assembly misalignment under the same assembly accuracy, thereby making it possible to achieve lightweight and reduce material costs. In addition, the first housing and the second housing are in direct contact with each other by three supporting cylinders, so that the adhesive layer between the two housings is less likely to overflow during assembly, and it is possible to avoid deflection when the first housing and the second housing are assembled so as to prevent the risk of decline of assembly yield. On the other hand, when there are less than three supporting cylinders, it is also possible to prevent the inclination problem caused by a lack of effective support for the first housing and the second housing during assembly.

Moreover, when the above two conditional expressions are met, even under certain accuracy, material yield strength and assembly force (such as 0.05 mm, 6 Mpa and 6 kgw), it is also possible for the eyepiece optical module to assemble the first housing and the second housing by using the dispensing method. In this way, it may be prevented that the radius of the supporting cylinder is too small and misalignment causes damage during assembly, or the radius of the supporting cylinder is too large, leading to the risk of overflow of adhesive. Furthermore, through the design of the mutual engagement between the supporting cylinder and the guide groove, the probability of misalignment of the first housing and the second housing during assembly may be significantly reduced. The assembly is convenient and the assembly yield is improved as well.

In order to make the above-mentioned features and advantages of the present invention more obvious and comprehensible, embodiments are given below and described in detail with reference to the attached drawings.

### BRIEF DESCRIPTION OF THE DRAWINGS

FIG. 1 is a schematic cross-sectional view of an eyepiece optical module in the related art.

FIG. 2 is a schematic side view of an eyepiece optical module according to an embodiment of the present invention.

FIG. 3 is an exploded view of the eyepiece optical module of FIG. 2.

FIG. 4A is a schematic top view of the first housing according to an embodiment of the present invention.

FIG. 4B is a schematic top view of the first housing and the first lens element after assembly according to an embodiment of the present invention.

FIG. 4C is a partially enlarged schematic view of FIG. 4B.

FIG. 5A to FIG. 5C are enlarged schematic views of an eyepiece optical module according to an embodiment of the present invention, taken along the cross-section line A-A′ of FIG. 4B.

FIG. 6A to FIG. 6C are enlarged schematic views of an eyepiece optical module according to an embodiment of the present invention, taken along the cross-section line B-B′ of FIG. 4B.

FIG. 7A to FIG. 7C are enlarged schematic views of an eyepiece optical module according to an embodiment of the present invention, taken along the cross-section line C-C′ of FIG. 4B.

FIG. 8 is a schematic top view of the first housing according to an embodiment of the present invention.

FIG. 9A to FIG. 9C are schematic side views, top views and cross-sectional views of a supporting cylinder and a guide groove according to an embodiment of the present invention.

FIG. 10A and FIG. 10B are schematic assembly diagrams of a second lens element and a first housing of an eyepiece optical module according to an embodiment of the present invention.

FIG. 11A and FIG. 11B are schematic assembly diagrams of a first lens element and a first housing of an eyepiece optical module according to another embodiment of the present invention.

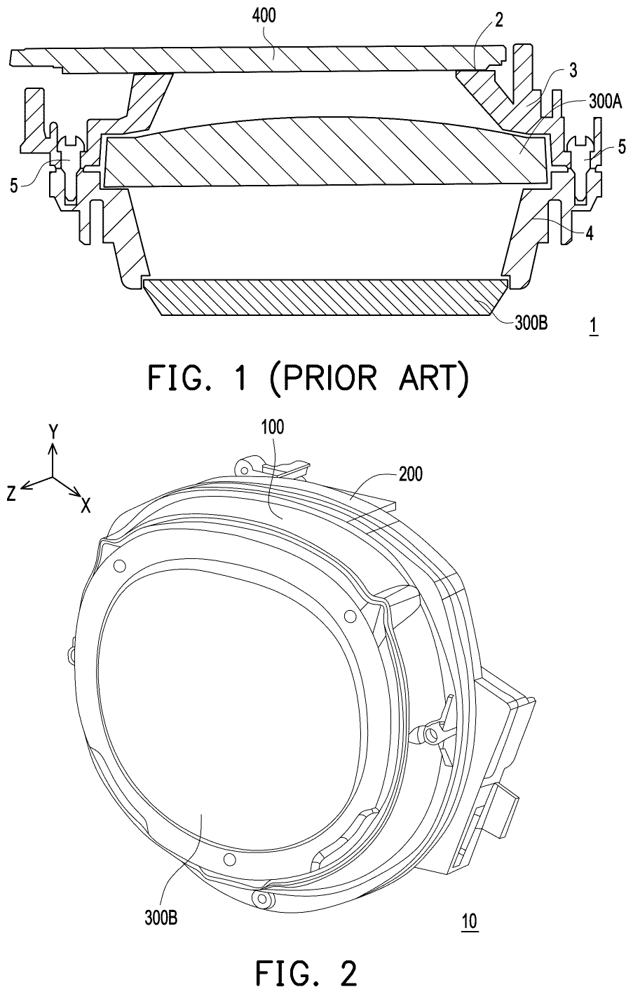

### DESCRIPTION OF THE EMBODIMENTS

Considering the particular amount of measurement and measurement-related errors discussed (i.e., the limitations of the measurement system), the terminology “about,” “approximately,” “essentially,” or “substantially” used herein includes the average of the stated value and an acceptable range of deviations from the particular value as determined by those skilled in the art. For instance, the terminology “about” may refer to as being within one or more standard deviations of the stated value, or within ±30%, ±20%, ±15%, ±10%, or ±5%. Furthermore, the terminology “about,” “approximately,” “essentially,” or “substantially” as used herein may be chosen from a range of acceptable deviations or standard deviations depending on the measurement properties, cutting properties, or other properties, rather than one standard deviation for all properties.

In the accompanying drawings, the thickness of layers, films, panels, regions, and so forth are enlarged for clarity. It should be understood that when an element, such as a layer, a film, a region, or a substrate is referred to as being “on” or “connected to” another element, it can be directly on or connected to another element, or an intermediate element may also be present. By contrast, when an element is referred to as being “directly on” or “directly connected to” another element, no intermediate element is present. As used herein, being “connected” may refer to a physical and/or electrical connection.

Reference will now be made in detail to the exemplary embodiments of the disclosure, examples of which are illustrated in the accompanying drawings. Whenever possible, the same reference numbers are used in the drawings and the description to refer to the same or like parts.

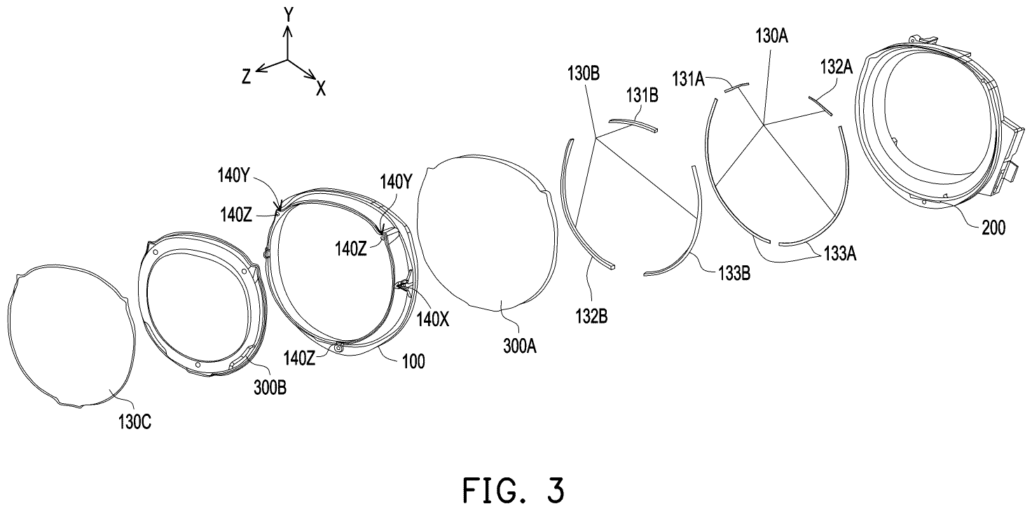

FIG. 2 is a schematic side view of an eyepiece optical module according to an embodiment of the present invention, and FIG. 3 is an exploded view of the eyepiece optical module of FIG. 2. Please refer to FIG. 2 and FIG. 3 simultaneously. The eyepiece optical module 10 includes a first housing 100, a second housing 200, a first lens element 300A, a second lens element 300B and a display (not shown). The display and the first lens element 300A are respectively located on opposite sides of the second housing 200 in a direction Z. The display is configured to provide a display light beam, and after the display light beam passes through the second housing 200, the first lens element 300A, the first housing 100 and the second lens element 300B in sequence along the direction Z, the display light beam is transmitted to the eyes (not shown) of the user to generate a display image. The material of the first housing 100 and the second housing 200 may be, for example, plastic. The material of the first lens element 300A and the second lens element 300B may be, for example, a plastic optical molding material, such as poly(methyl methacrylate) (PMMA), polycarbonate (PC), etc., the present invention is not limited thereto. The direction Z described herein may represent the extension direction of the optical axis of the eyepiece optical module 10.

The eyepiece optical module 10 further includes multiple adhesive layers to firmly connect and fasten the first lens element 300A, the second lens element 300B, the first housing 100 and the second housing 200. For example, the first lens element adhesive layer 130B may be disposed around the first lens element 300A, so that the first lens element 300A may be connected to one side of the first housing 100 (for example, one side of the first housing 100 away from the direction Z). Similarly, the second lens element adhesive layer 130C may be disposed around the second lens element 300B, so that the second lens element 300B may be connected to the other side of the first housing 100 (for example, one side of the first housing 100 facing the direction Z). The first adhesive layer 130A may be configured to connect the first housing 100 and the second housing 200 to each other, so that the first lens element 300A may be disposed between the first housing 100 and the second housing 200. The types of the first adhesive layer 130A, the first lens element adhesive layer 130B and the second lens element adhesive layer 130C may be epoxy resin or UV glue, and the invention is not limited thereto. It is worth mentioning that the eyepiece optical module 10 of the present invention may effectively prevent the glue overflow problem when coating each adhesive layer mentioned above (to be described later).

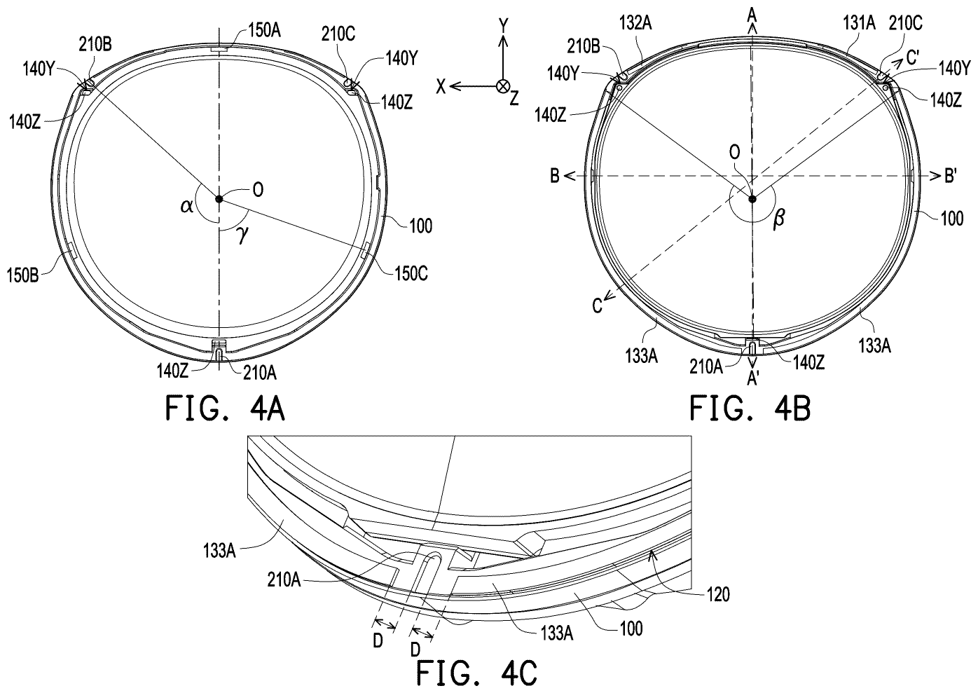

FIG. 4A is a schematic top view of the first housing according to an embodiment of the present invention. FIG. 4B is a schematic top view of the first housing and the first lens element after assembly according to an embodiment of the present invention. FIG. 4C is a partially enlarged schematic view of FIG. 4B. Please refer to FIG. 3 to FIG. 4C simultaneously. One of the first housing 100 and the second housing 200 includes at least three supporting cylinders 110A to 110C, and the other includes at least three guide grooves 210A to 210C. The first housing 100 and the second housing 200 may be aligned with each other in a connecting manner only by the at least three supporting cylinders 110A to 110C and the at least three guide grooves 210A to 210C. That is to say, other parts of the first housing 100 and the second housing 200 may not contact each other but in alignment contact with each other only with the at least three supporting cylinders 110A to 110C and the at least three guide grooves 210A to 210C. In other embodiments, the number of guide grooves and the number of supporting cylinders may be only three or more than three, the present invention is not limited thereto. If there are only three supporting cylinders 110A to 110C and three guide grooves 210A to 210C in direct contact with each other between the first housing 100 and the second housing 200, it is possible to reduce the overflow of glue between the supporting cylinders 110A to 110C in direct contact with each other between the first housing 100 and the second housing 200 during assembly, thereby reducing the probability and risk of yield decline due to eccentricity of the eyepiece optical system.

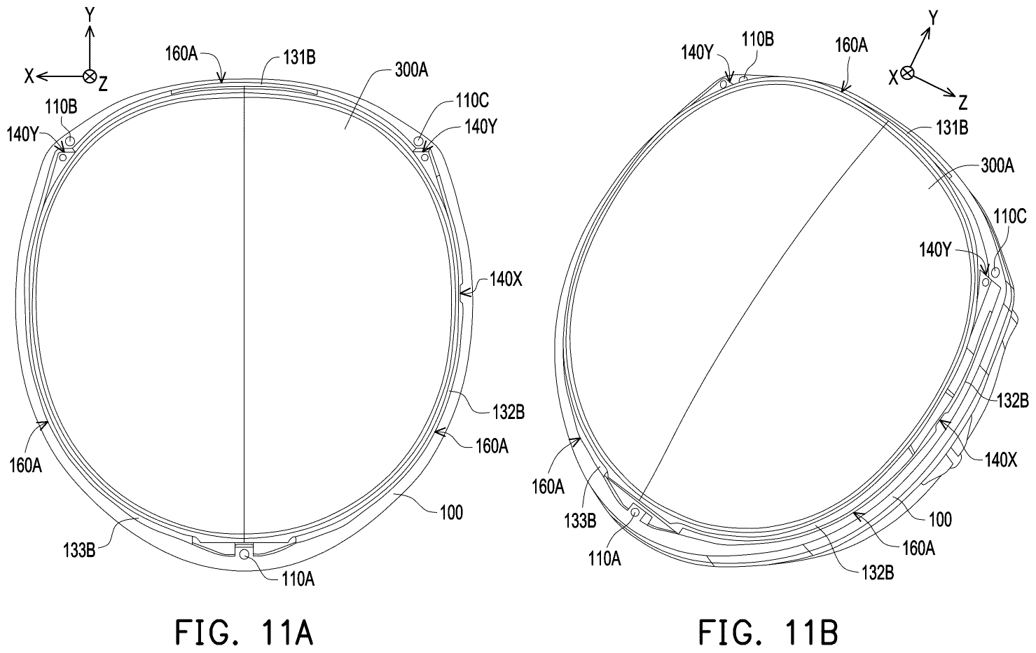

FIG. 11A and FIG. 11B are schematic assembly diagrams of the first lens element and the first housing of an eyepiece optical module according to another embodiment of the present invention. Please refer to FIG. 4A to FIG. 4C as well as FIG. 11A and FIG. 11B. For ease of explanation, in FIG. 4A to FIG. 4C, the implementation is exemplified with the first housing 100 including three guide grooves 210A to 210C, and the second housing 200 including three supporting cylinders (not shown in FIG. 4A to FIG. 4C). However, the present invention is not limited thereto. In the embodiments of FIG. 11A and FIG. 11B, the first housing 100 may also include three supporting cylinders 110A to 110C, and the second housing 200 may include three guide grooves 210A to 210C (not shown in FIG. 11A to FIG. 11B). It is worth mentioning that any of the three supporting cylinders 110A to 110C satisfies the following conditional expressions: 0.20≤r1/H1≤4.40 and 0.34 mm≤r1≤1.35 mm, wherein r1 is a radius of a bottom surface at one end of the supporting cylinders 110A to 110C, and H1 is a height of the supporting cylinders 110A to 110C on the first housing 100. In an embodiment where the supporting cylinders 110A to 110C are disposed on the second housing 200, H1 may also be a height of the supporting cylinders 110A to 110C on the second housing 200. In some embodiments, the following conditional expressions may also be further satisfied: 0.80≤r1/H1≤2.80 and 0.40 mm≤r1≤0.82 mm.

Since the supporting surface of the supporting cylinders 110A to 110C is circular, and the radius r1 and the height H1 satisfy the above conditional expressions, which not only facilitate mold processing, but also reduce the risk of excessive local stress between the first housing 100 and the second housing 200. Moreover, increasing the supporting area for assembly misalignment between the first housing 100 and the second housing 200 under the same assembly accuracy makes it possible to achieve lightweight of the eyepiece optical module 10 and reduce material costs. In addition, the first housing 100 and the second housing 200 directly contact each other through solid components such as the three supporting cylinders 110A to 110C and the guide grooves 210A to 210C, so that the first adhesive layer 130A between the two housings is less likely to overflow due to squeezing during assembly. In this way, it is possible to avoid deflection when the first housing 100 and the second housing 200 are assembled so as to prevent the risk of decline of assembly yield. On the other hand, when there are less than three supporting cylinders, it is also possible to prevent the inclination problem caused by a lack of effective support for the first housing 100 and the second housing 200 during assembly. In addition, the textures and patterns of the three supporting cylinders 110A to 110C and the three guide grooves 210A to 210C also render visual recognition easy, thus reducing the difficulty of assembly of the eyepiece optical module 10, thereby increasing the assembly yield.

Please continue to refer to FIG. 4A and FIG. 4B. In order to further reduce the risk of glue overflow of the first adhesive layer 130A and stabilize the assembly between the first housing 100 and the second housing 200, the relative positions of the three supporting cylinders 110A to 110C and the three guide grooves 210A to 210C may be optimized. For example, any two of the three supporting cylinders 110A to 110C (substantially the corresponding positions of the three guide grooves 210A to 210C in FIG. 4A) may form two connection lines relative to a center O of the first housing 100, and an angle α formed by the two connection lines may have the following range: 90 degrees≤α≤135 degrees. In this way, it is possible for the three guide grooves 210A to 210C of the first housing 100 and the three supporting cylinders 110A to 110C of the second housing 200 to be docked with each other. In some embodiments, the angle α may be, for example, 120 degrees. That is to say, if the periphery of the first housing 100 is approximated as a circle, the center O of the first housing 100 may be approximated as the center of the circle, and the central angle formed by any two of the three supporting cylinders 110A to 110C or any two of the three guide grooves 210A to 210C relative to the center O may be substantially 120 degrees.

With the above configuration of the angle α, the three supporting cylinders 110A to 110C are evenly distributed relative to the center O, so that the first housing 100 and the second housing 200 may remain stable when being assembled, and each part of the first adhesive layer 130A is subjected to substantially the same stress, thus reducing the risk of glue overflowing to other parts, or even glue overflowing to the first lens element 300A and blocking the display light beam.

Please continue to refer to FIG. 4A and FIG. 4B. It is worth mentioning that, in order to facilitate the assembly of the first lens element 300A and the first housing 100, the first housing 100 may further include a first direction limiting pillar 140X, two second direction limiting pillars 140Y and three third direction limiting pillars 140Z. The first direction limiting pillar 140X, the second direction limiting pillars 140Y and the third direction limiting pillars 140Z, for example, are bumps integrally formed with the first housing 100 and facing the first lens element 300A, for contacting and fastening the first lens element 300A.

Specifically, the first direction limiting pillar 140X is, for example, disposed in the negative direction X in FIG. 4A and contacts the first lens element 300A to limit the lateral movement of the first lens element 300A in the direction X. The two second direction limiting pillars 140Y, for example, as shown in FIG. 4A, are disposed in the direction Y of the first lens element 300A and contact both ends of the first lens element 300A extending in the direction X to limit the lateral movement of the first lens element 300A in the direction Y. Similarly, the three third direction limiting pillars 140Z are, for example, respectively disposed adjacent to the three guide grooves 210A to 210C to respectively abut against the first lens element 300A to prevent the first lens element 300A from moving laterally in the direction Z. Likewise, as shown in the exploded view of FIG. 3, the other side of the first housing 100 may also be provided with a first direction limiting pillar 140X, two second direction limiting pillars 140Y and three third direction limiting pillars 140Z to fasten the second lens element 300B, the relevant relationships between components may be derived from the above descriptions and will not be repeated here.

On the other hand, before each component is packaged, the first lens element 300A and the second lens element 300B may also be pre-fixed to prevent the first lens element 300A and the second lens element 300B from being shifted or even separated during assembly. For example, the first housing 100 may further include a pre-fixing glue tank 150A, a pre-fixing glue tank 150B and a pre-fixing glue tank 150C, as well as dispensing materials (not shown) disposed in the pre-fixing glue tanks 150A to 150C. The three pre-fixing glue tanks 150A to 150C and the three third direction limiting pillars 140Z may be further arranged in an alternated manner. For example, there is an angle γ formed by the connection line formed by any one of the three pre-fixing glue tanks 150A to 150C and the center O and the connection line formed by any one of the three third direction limiting pillars 140Z and the center O, and the angle γ may be greater than or equal to 45 degrees (that is, the minimum value of angle γ formed by any one of the pre-fixing glue tanks 150A to 150C and the adjacent third direction limiting pillar 140Z with the center O respectively may be 45 degrees). In some embodiments, the angle γ may be substantially 60 degrees. From another perspective, if the periphery of the first housing 100 is approximated as a circle, the center O of the first housing 100 may be approximated as the center of the circle. The three third direction limiting pillars 140Z and the three pre-fixing glue tanks 150A to 150C may be distributed alternately with each other on the circumference, and the central angle formed by the third direction limiting pillar 140Z and any one of the adjacent pre-fixing glue tanks 150A to 150C is the angle α, the angle γ may be essentially 60 degrees. Of course, the present invention is not limited thereto. In some embodiments, the angle γ may be in a range of greater than or equal to 45 degrees and less than or equal to 80 degrees.

The above configuration facilitates the staggered arrangement of the pre-fixing glue tanks 150A to 150C and the third direction limiting pillars 140Z to prevent the glue in the pre-fixing glue tanks 150A to 150C from overflowing between the first housing 100 and the first lens element 300A and causing the eyepiece optical module 10 to be eccentric. In this way, correct assembly may be realized and the first lens element 300A may be accurately aligned. Similarly, the second lens element 300B may also be provided with three pre-fixing glue tanks and the dispensing materials disposed in the three pre-fixing glue tanks (both are not shown) on one side of the first housing 100 facing away from the first lens element 300A, so as to pre-fix the second lens element 300B. Relevant configuration and functions may be derived from the above descriptions and will not be repeated here.

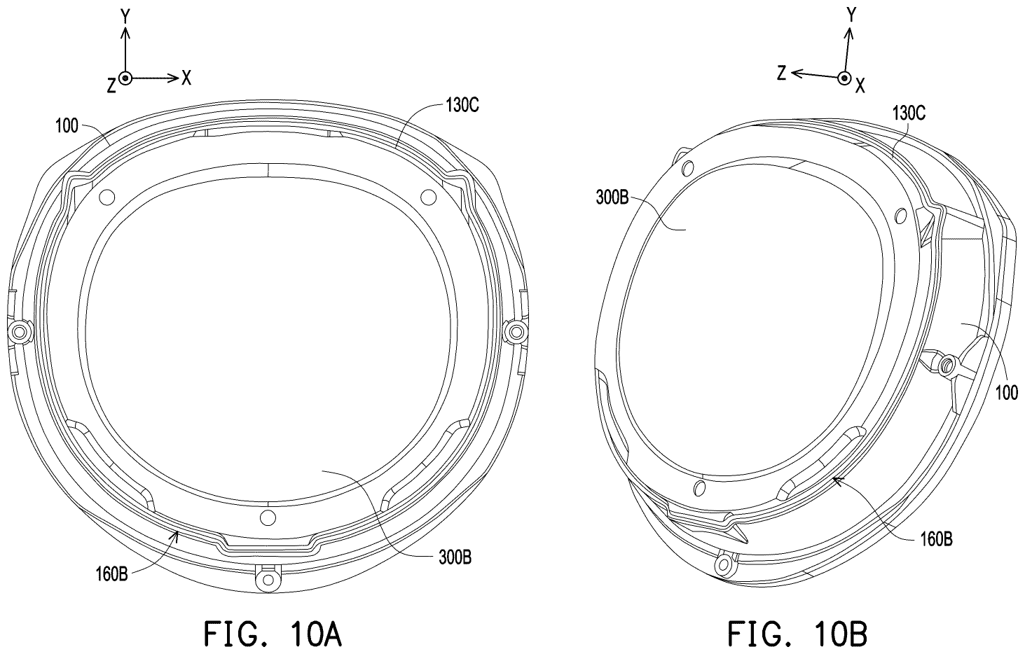

FIG. 10A and FIG. 10B are schematic assembly diagrams of the second lens element and the first housing of an eyepiece optical module according to an embodiment of the present invention. Please refer to FIG. 3 and FIG. 10A to FIG. 11B first. After the first lens element 300A and the second lens element 300B are pre-fixed through the pre-fixing glue tanks 150A to 150C, the first lens element adhesive layer 130B may be further disposed to adhere the first lens element 300A and the first housing 100, and the second lens element adhesive layer 130C may be disposed to adhere the second lens element 300B and the first housing 100.

Specifically, as shown in FIG. 3, FIG. 10A and FIG. 10B, a lens element glue tank 160B may be formed around the second lens element 300B and in between the first housing 100. The second lens element adhesive layer 130C may be further disposed in the lens element glue tank 160B and completely surround the circumference of the second lens element 300B to connect the second lens element 300B to the first housing 100. Likewise, as shown in FIG. 3, FIG. 11A and

FIG. 11B, there is a substantially circumferential portion around the first lens element 300A, and a lens element glue tank 160A may be formed between the first lens element 300A and the first housing 100. The first lens element adhesive layer 130B may be further disposed in the lens element glue tank 160A. In detail, the first lens element adhesive layer 130B may be further divided into a first portion 131B, a second portion 132B and a third portion 133B. The first lens element 300A may have an imaginary symmetry axis facing the direction Y, and the second portion 132B and the third portion 133B may be respectively disposed on opposite sides of the above-mentioned symmetry axis. The symmetry axis may further pass through the first portion 131B. However, the present invention is not limited thereto. It is worth mentioning that each part of the first lens element adhesive layer 130B may be kept at a certain distance from the aforementioned first direction limiting pillar 140X, the second direction limiting pillars 140Y and the supporting cylinders 110A to 110C, and is not coated on the above-mentioned components.

The above configuration helps to fix the first lens element 300A and the second lens element 300B within the first housing 100 with a limited volume, while preventing the first lens element 300A and the second lens element 300B from falling or being separated due to external force after being assembled to the first housing 100, thereby increasing the reliability of the connection between components and reducing the probability of glue overflow.

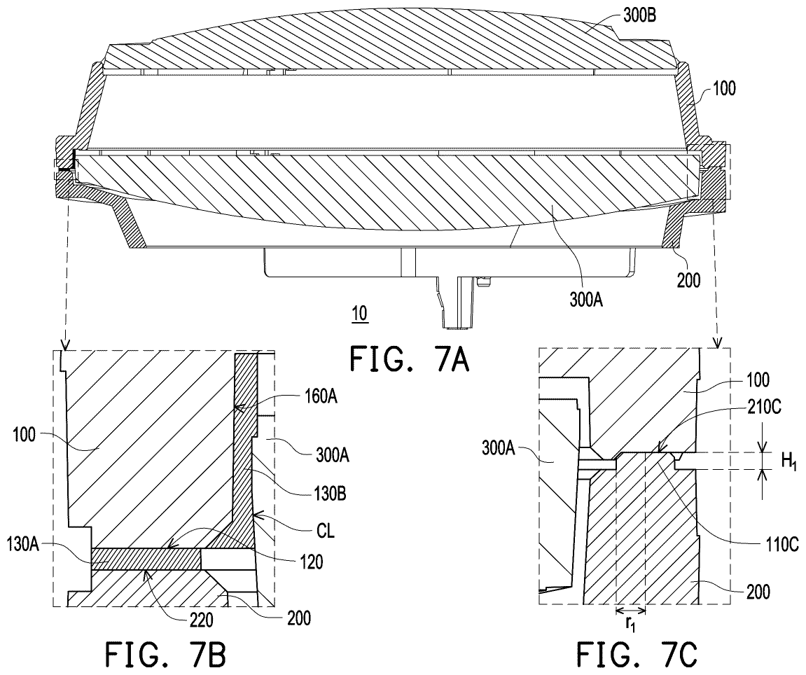

Please continue to refer to FIG. 3, FIG. 4B to FIG. 4C. After the first lens element 300A and the second lens element 300B are adhered to the first housing 100, the first housing 100 and the second housing 200 may be further bonded through the first adhesive layer 130A. Furthermore, the first housing 100 and the second housing 200 may each have a platform (for example, a platform 120 on the first housing 100 in FIG. 4C, and a platform 220 on the second housing 200 in FIG. 7B), and a space may be formed between the two platforms. The first adhesive layer 130A may have a first portion 131A, a second portion 132A and a third portion 133A being disposed in the above-mentioned space and further satisfying the following conditional expression: 230 degrees≤β≤270 degrees, wherein β is an angle covered by the third portion 133A in the first adhesive layer 130A in the platform relative to the center O. However, the invention is not limited thereto. In some embodiments, the first portion 131A and second portion 132A may be omitted. In this way, it is possible to prevent the first housing 100 and the second housing 200 from falling or being separated due to external force after assembly.

In some embodiments, a distance between any of the three supporting cylinders 110A to 110C (that is, the supporting positions of the three guide grooves 210A to 210C and the three supporting cylinders 110A to 110C in FIG. 4A to FIG. 4C) and the first adhesive layer 130A may be greater than or equal to 0.5 mm. For example, in the enlarged view of FIG. 4C, a distance D between the opposite sides of the guide groove 210A and the third portion 133A of the first adhesive layer 130A may be greater than or equal to 0.5 mm. However, the present invention is not limited thereto. In some embodiments, the distance D may be approximately 1.4 mm. The supporting cylinders 110B to 110C may also be configured as above, and the related details will not be described again here. The above configuration allows the first adhesive layer 130A to be kept at a certain distance from the supporting cylinders 110A to 110C and the guide grooves 210A to 210C to prevent the components from being too close to each other and interfering with image recognition during assembly. In addition, the first adhesive layer 130A is not disposed in the guide grooves 210A to 210C, so as to further reduce the risk of glue overflow from the first adhesive layer 130A. It is worth mentioning that since the distance D and the width of the guide groove 210A are smaller than the space around the first housing 100 in proportion, the range of the angle β as shown in FIG. 4B may be approximately equal to the range of the angle covered by the third portion 133A in the platform relative to the center O.

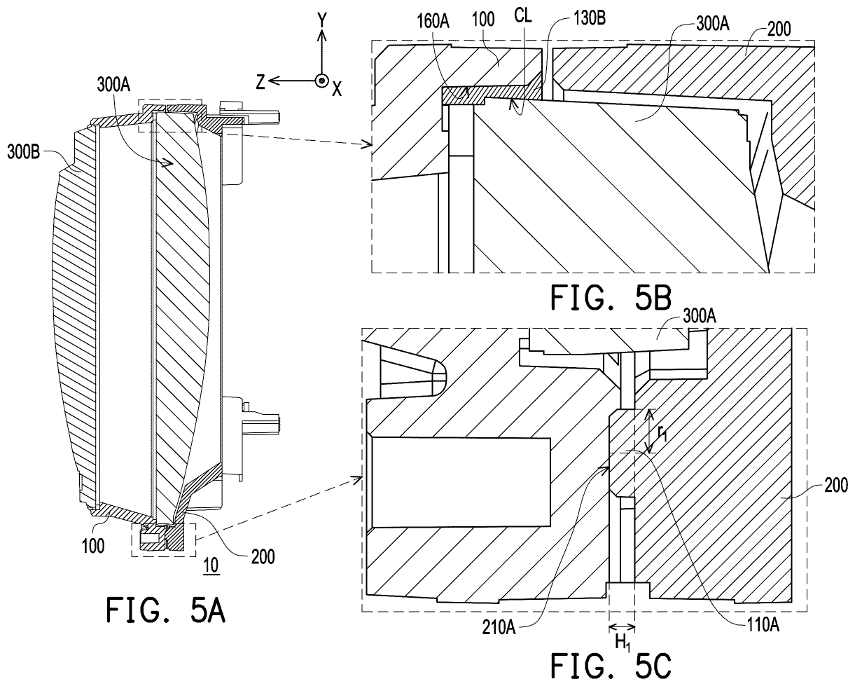

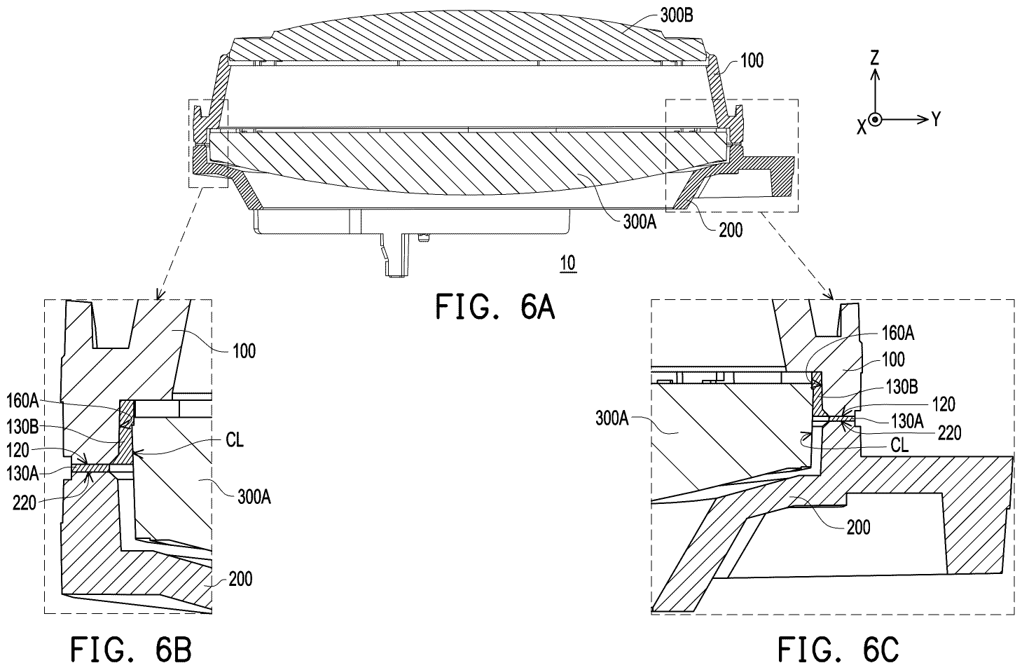

FIG. 5A to FIG. 5C are enlarged schematic views of an eyepiece optical module according to an embodiment of the present invention, taken along the cross-section line A-A′ of FIG. 4B. FIG. 6A to FIG. 6C are enlarged schematic views of an eyepiece optical module according to an embodiment of the present invention, taken along the cross-section line B-B′ of FIG. 4B. FIG. 7A to FIG. 7C are enlarged schematic views of an eyepiece optical module according to an embodiment of the present invention, taken along the cross-section line C-C′ of FIG. 4B. FIG. 5B further shows the joint method between the first lens element 300A, the first housing 100 and the second housing 200. It can be seen from FIG. 5B that a lens element glue tank 160A may be formed between the circumference CL of the first lens element 300A and the first housing 100, and the first lens element adhesive layer 130B may be further disposed in the lens element glue tank 160A.

On the other hand, FIG. 5C further illustrates the supporting method for the first housing 100 and the second housing 200 with the supporting cylinder 110A and the guide groove 210A disposed in between. As shown in FIG. 5C, the height H1 of the supporting cylinder 110A as the hardware component enables a distance to be maintained between the first housing 100 and the second housing 200.

Please refer to FIG. 6A to FIG. 6C. Since the cross-section line B-B′ does not pass through the supporting cylinders 110A to 110C and the guide grooves 210A to 210C, it is merely shown how the first adhesive layer 130A is connected to the first housing 100 and the second housing 200. Similar to the above, the first adhesive layer 130A is formed in the space formed by the platform 120 and the platform 220, and the first lens element adhesive layer 130B is formed in the lens element glue tank 160A formed between the circumference CL and the first housing 100.

Please refer to FIG. 7A to FIG. 7C. Since the cross-section line C-C′ passes through the supporting cylinder 110C and the guide groove 210C, it is possible to see the mutual supporting relationship between the supporting cylinder 110C and the guide groove 210C from FIG. 7C, and it is shown in FIG. 7B how the first adhesive layer 130A is connected between the first housing 100 and the second housing 200. In this way, during assembly, the first adhesive layer 130A disposed in the space formed by the platform 120 and the platform 220 may be subjected to stress evenly, thereby reducing the probability of the first adhesive layer 130A overflowing to other components.

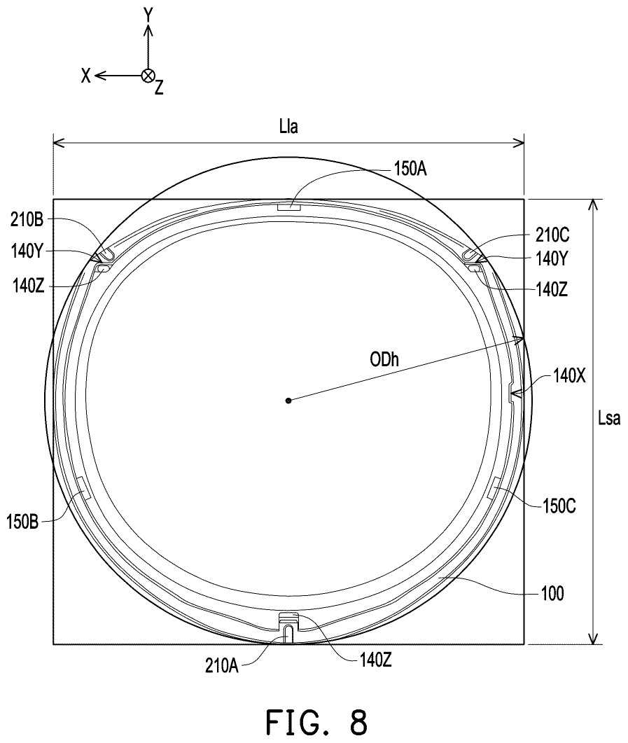

FIG. 8 is a schematic top view of the first housing according to another embodiment of the present invention. Please refer to FIG. 8. The sizes of the supporting cylinders 110A to 110C of the eyepiece optical module 10 may also be set to satisfy the following conditional expressions: 0.20≤r1/H1≤4.40 and 45.00≤ODh/r1≤190.00, wherein r1 is a radius of the supporting cylinders 110A to 110C, H1 is a height of the supporting cylinders 110A to 110C, and ODh is a maximum outer diameter of the first housing 100. For example, if the center O of the first housing 100 is taken as the center of the circle, the maximum outer diameter ODh is, for example, the radius of the circumscribed circle of the projection shape (that is, the projection on the plane composed of the direction X and the direction Y) of the first housing 100 on the element surface. In some embodiments, the following conditional expressions may also be further satisfied: 0.80≤r1/H1≤2.80 and 75.00≤ODh/r1≤165.00. Under the above conditions, the eyepiece optical module 10 may also achieve the effects of reducing the risk of glue overflow and being easy to assemble. The relevant principles and features may be derived from the previous descriptions and will not be described again here.

In some embodiments, the size of the first housing 100 may further satisfy the following conditional expression: 45.00≤L1a/r1≤185.00, wherein L1a is the length of the long axis of the first housing 100 in the direction X. In some embodiments, the following conditional expression may be further satisfied: 75.00≤L1a/r1≤160.00, or: 47.63≤L1a/r1≤183.01. On the other hand, the following conditional expression may be further satisfied: 40.00≤Lsa/r1≤175.00, wherein Lsa is the length of the short axis of the first housing 100 in the direction Y. On the other hand, the following conditional expression may be further satisfied: 70.00≤Lsa/r1≤150.00, or: 45.20≤Lsa/r1≤173.69. Through the above configuration, the long axis L1a and the short axis Lsa may be designed properly to prevent the radius r1 of the supporting cylinders 110A to 110C from being too small and causing damage due to misalignment during assembly, or the radius r1 being too large and increasing the risk of glue overflow.

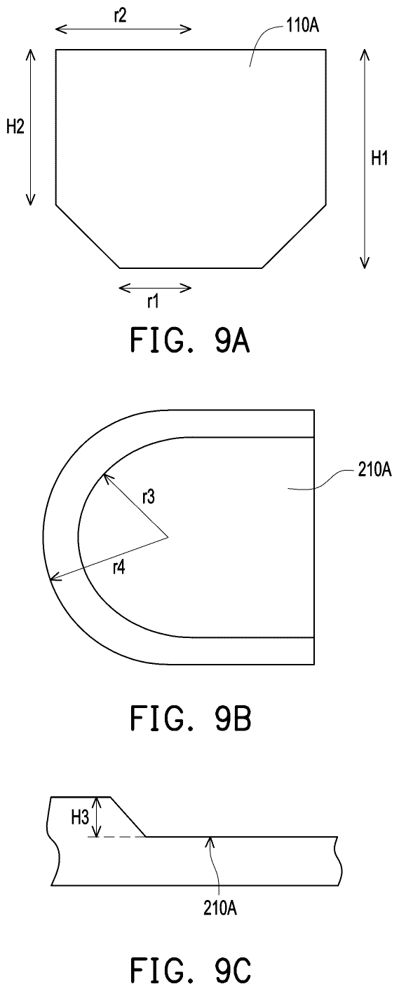

FIG. 9A to FIG. 9C are schematic side views, top views and cross-sectional views of a supporting cylinder and a guide groove according to an embodiment of the present invention. It should be noted that the supporting cylinder 110A and the guide groove 210A are used for an exemplary explanation here. The design of the supporting cylinders 110B to 110C and the guide grooves 210B to 210C may be the same as the supporting cylinder 110A and the guide groove 210A, and no further details are provided herein. The supporting cylinders 110A to 110C and the guide grooves 210A to 210C may be further designed. Taking the supporting cylinders 110A to 110C disposed on the first housing 100 as an example, the shape of one end of the supporting cylinders 110A to 110C facing away from the first housing 100 may be a truncated cone, and further satisfy the following conditional expressions: 0 mm≤H2≤6.68 mm; 0.80≤r1/r3≤1.00; and 0.80≤r2/r4≤1.20, wherein H2 is a difference between H1 and a height of the truncated cone; r2 is a radius of the other end of the supporting cylinders 110A to 110C, that is, the radius of the connection between the supporting cylinders 110A to 110C and the first housing 100; r3 is a radius of curvature of a bottom portion of guide grooves 210A to 210C, and r4 is a radius of curvature of a top portion of the guide grooves 210A to 210C. The “bottom portion” mentioned here may refer to the part where the guide grooves 210A to 210C and the supporting cylinders 110A to 110C actually come into contact when they are supported, and the “top portion” mentioned here may refer to the outermost contour of the guide grooves 210A to 210C in appearance.

By designing the supporting cylinders 110A to 110C and the guide grooves 210A to 210C to have inner radii (i.e., radius r1 and radius of curvature r3) and outer radii (i.e., radius r2 and radius of curvature r4) respectively, it is possible to simultaneously reduce the probability of misalignment when the first housing 100 and the second housing 200 are assembled and aligned.

On the other hand, the sizes of the guide grooves 210A to 210C may also be further limited. For example, the depth H3 of the guide grooves 210A to 210C is greater than or equal to 0.005 mm. When the depth H3 is deep enough, it is possible to facilitate image recognition of the first housing 100 and the second housing 200 during assembly, thereby improving the assembly yield of the eyepiece optical module 10.

TABLE 1

| | r1(mm) | Area(mm²) | Total area(mm²) |
|---|---|---|---|
| Size limit | 0.317 | 0.316 | 0.948 |

Table 1 is a parameter table based on which the sizes of the supporting cylinders 110A to 110C of the present invention are designed. When the first housing 100 and the second housing 200 are assembled, the material yield strength (that is, the ultimate stress of the first housing 100 and the second housing 200 against deformation) of the material is about 62 Mpa (millions of pascals, the unit is 10⁶ N/m²=1N/mm²), and the maximum force between the first housing 100 and the second housing 200 during the assembly process is approximately 6 kilogram-weight (Kgw). Under the above conditions, the contact area between the first housing 100 and the second housing 200 should be at least 0.948 mm² (square millimeters) to ensure the reliability between both the first housing 100 and the second housing 200 during assembly. If three supporting cylinders 110A to 110C are provided for the first housing 100 and the second housing 200 to contact each other, the area of any one of the three supporting cylinders 110A to 110C should be at least 0.948/3=0.316 (mm²). After conversion, the radius r1 of the bottom surface of any one of the supporting cylinders 110A to 110C should be at least approximately 0.317 millimeters (mm).

TABLE 2

| | | | | | |
|---|---|---|---|---|---|
| Current | | Minimum | Maximum | Preferred | Preferred |
| design | Parameter | value | value | lower limit | upper limit |

Dimensional parameters of supporting cylinder 110A, supporting cylinder 110B and supporting cylinder 110C

| | | | | | |
|---|---|---|---|---|---|
| 0.50 mm | r1 | 0.342 mm | 1.315 mm | 0.400 mm | 0.820 mm |
| 0.60 mm | r2 | 0.367 mm | 1.340 mm | | |
| 0.35 mm | H1 | 0.300 mm | 6.700 mm | 0.300 | 0.500 |
| 0.25 mm | H2 | 0.000 mm | 6.680 mm | 0.000 | 0.480 |
| 1.43 | r1:H1 | 0.200 | 4.383 | 0.800 | 2.733 |
| 2.40 | r2:H2 | | | | |
| 125.26 | Lla/r1 | 47.627376 | 183.0122201 | 156.575 | 76.37804878 |
| 118.88 | Lsa/r1 | 45.201521 | 173.6906652 | 148.6 | 72.48780488 |
| 128.00 | ODh/r1 | 49.353612 | 189.6454269 | 162.25 | 79.14634146 |

Dimensional parameters of guide groove 210A, guide groove 210B and guide groove 210C

| | | | | | |
|---|---|---|---|---|---|
| 0.5 mm | r3 | 0.342 mm | 1.315 mm | 0.400 | 0.820 |
| 0.6 mm | r4 | 0.367 mm | 1.340 mm | | |
| 0.15 mm | H3 | 0.005 mm | 6.680 mm | | |
| | r3:H3 | 0.200 | 263.000 | | |
| | r1/r3 | 0.8 | 1 | 0.9 | 1 |
| | r2/r4 | 0.8 | 1.2 | 0.9 | 1.1 |

Dimensional parameters of first housing 100 and second housing 200

| Current | | Minimum | Maximum | Preferred lower | Preferred upper |
|---|---|---|---|---|---|
| design (mm) | Parameter | value (mm) | value (mm) | limit (mm) | limit (mm) |
| 62.63 | Lla | 47.627376 | 183.0122201 | 76.37804878 | 156.575 |
| 59.44 | Lsa | 45.201521 | 173.6906652 | 72.48780488 | 148.6 |

Table 2 is a corresponding numerical table of the parameters of various elements mentioned above. In order to meet the conditions described in Table 1, each parameter may correspond to Table 2. It should be noted that the radius r1 of the bottom surface of the supporting cylinders 110A to 110C should be at least 0.317 (mm), and the process tolerance is about 0.05 (mm), so the minimum value of the radius r1 may be 0.317+(0.05/2)=0.342 (mm) when the tolerance is taken into consideration. Similarly, in FIG. 8A, the radius r2 of the bottom surface of the other end of the supporting cylinders 110A to 110C is larger than the radius r1, and the minimum value of the radius r2 may be 0.342+(0.05/2)=0.367 (mm). On the other hand, in order to meet the condition that the tolerances of the height H1 and the depth H3 are both 0.02 (mm), the processing tolerance of the platform being 0.06 (mm), and the interval reserved for dispensing being 0.2 mm, the height H1 of the supporting cylinders 110A to 110C may be 0.02+0.02+0.06+0.2=0.3 (mm). Under the above conditions, the supporting cylinders 110A to 110C and the guide grooves 210A to 210C of the present invention may exert a good supporting function, so that the eyepiece optical module 10 may achieve the aforementioned technical effects.

Based on the above, the eyepiece optical module according to the embodiments of the present invention is assembled with a supporting cylinder. The circular supporting surface facilitates mold processing, while reducing the risk of excessive local stress, and increasing the supporting area for assembly misalignment under the same assembly accuracy, thereby making it possible to achieve lightweight and reduce material costs. In addition, the first housing and the second housing are in direct contact with each other by three supporting cylinders, so that the adhesive layer between the two housings is less likely to overflow during assembly, and it is possible to avoid deflection when the first housing and the second housing are assembled so as to prevent the risk of decline of assembly yield. On the other hand, when there are less than three supporting cylinders, it is also possible to prevent the inclination problem caused by a lack of effective support for the first housing and the second housing during assembly.

Moreover, when the above two conditional expressions are met, even under certain accuracy, material yield strength and assembly force (such as 0.05 mm, 6 Mpa and 6 kgw), it is also possible for the eyepiece optical module to assemble the first housing and the second housing by using the dispensing method. In this way, it may be prevented that the radius of the supporting cylinder is too small and misalignment causes damage during assembly, or the radius of the supporting cylinder is too large, leading to the risk of overflow of adhesive. Furthermore, through the design of the mutual engagement between the supporting cylinder and the guide groove, the probability of misalignment of the first housing and the second housing during assembly may be significantly reduced. The assembly is convenient and the assembly yield is improved as well.

Although the present invention has been disclosed above through embodiments, it is not intended to limit the present invention. Anyone with ordinary knowledge in the technical field can make some modifications and refinement without departing from the spirit and scope of the present invention. Therefore, the scope to be protected by the present invention shall be determined by the appended claims.

What is claimed is:

1. An eyepiece optical module, comprising:
a first housing;
a second housing, wherein one of the first housing and the second housing comprises at least three supporting cylinders, the other comprises at least three guide grooves, and only the supporting cylinders are in direct contact with the guide grooves between the first housing and the second housing;
a lens element disposed between the first housing and the second housing,
wherein any one of the three supporting cylinders satisfies the following conditional expression: 0.20≤r1/H1≤4.40 and 0.34 mm≤r1≤1.35 mm, wherein r1 is a radius of one end of the supporting cylinder and H1 is a height of the supporting cylinder.

2. The eyepiece optical module according to claim 1, wherein the first housing and the second housing have a center, and any two of the three supporting cylinders form two connection lines relative to the center, and an angle α formed by the two connection lines satisfies the following condition expression: 90 degrees≤α≤135 degrees.

3. The eyepiece optical module according to claim 2, wherein the first housing and the second housing each has a platform, and a space is formed by the platforms, an adhesive layer is disposed in the space and further satisfies the following conditional expression: 230 degrees≤β≤270 degrees, wherein β is an angle covered by the adhesive layer in the platform relative to the center.

4. The eyepiece optical module according to claim 3, wherein a distance between any of the three supporting cylinders and the adhesive layer is greater than or equal to 0.5 mm.

5. The eyepiece optical module according to claim 1, wherein the first housing further satisfies the following conditional expression: 45.00≤L1a/r1≤185.00, wherein L1a is a length of a long axis of the first housing.

6. The eyepiece optical module according to claim 1, wherein the first housing further satisfies the following conditional expression: 40.00≤Lsa/r1≤175.00, wherein Lsa is a length of a short axis of the first housing.

7. The eyepiece optical module according to claim 1, wherein the first housing has a first direction limiting pillar, two second direction limiting pillars and three third direction limiting pillars, wherein a first direction, a second direction and a third direction are perpendicular to each other, and the first direction limiting pillar, the second direction limiting pillars and the third direction limiting pillars are in direct contact with the lens element.

8. The eyepiece optical module according to claim 7, wherein the first housing has a center and three pre-fixing glue tanks, a connection line is formed by any one of the three pre-fixing glue tanks and the center, and an angle formed by any one of the three third direction limiting pillars and the center is greater than or equal to 45 degrees.

9. The eyepiece optical module according to claim 1, wherein the lens element has a circumference, and a lens element glue tank is formed between the circumference and the first housing.

10. The eyepiece optical module according to claim 1, wherein the one end of the supporting cylinder is a truncated cone and further satisfies the following conditional expressions:
$$0 mm ≦ H 2 ≦ 6.68 mm ;$$
$$0.8 ≦ r 1 / r 3 ≦ 1. ; and$$
$$0.8 ≦ r 2 / r 4 ≦ 1.20 ,$$
wherein H2 is a difference between H1 and a height of the truncated cone, r2 is a radius of the other end of the supporting cylinder, r3 is a radius of curvature of a bottom portion of the guide groove, and r4 is a radius of curvature of a top portion of the guide groove.

11. The eyepiece optical module according to claim 1, wherein a depth of the guide groove is greater than or equal to 0.005 mm.

12. An eyepiece optical module, comprising:
a first housing;
a second housing, wherein one of the first housing and the second housing comprises three supporting cylinders, the other comprises three guide grooves, and only the three supporting cylinders are in direct contact with the three guide grooves between the first housing and the second housing;
a lens element disposed between the first housing and the second housing,
wherein any one of the three supporting cylinders satisfies the following conditional expression: 0.20≤r1/H1≤4.40 and 45.00≤ODh/r1≤190.00, wherein r1 is a radius of a bottom surface of one end of the supporting cylinder, H1 is a maximum height of the supporting cylinder, and ODh is a maximum outer diameter of the first housing.

13. The eyepiece optical module according to claim 12, wherein the first housing and the second housing have a center, and any two of the three supporting cylinders form two connection lines relative to the center, and an angle α formed by the two connection lines satisfies the following condition expression: 90 degrees≤α≤135 degrees.

14. The eyepiece optical module according to claim 13, wherein the first housing and the second housing each has a platform, and a space is formed by the platforms, an adhesive layer is disposed in the space and further satisfies the following conditional expression: 230 degrees≤β≤270 degrees, wherein β is an angle covered by the adhesive layer in the platform relative to the center.

15. The eyepiece optical module according to claim 14, wherein a distance between any of the three supporting cylinders and the adhesive layer is greater than or equal to 0.5 mm.

16. The eyepiece optical module according to claim 12, wherein the first housing further satisfies the following conditional expression: 45.00≤L1a/r1≤185.00, wherein L1a is a length of a long axis of the first housing.

17. The eyepiece optical module according to claim 12, wherein the first housing further satisfies the following conditional expression: 40.00≤Lsa/r1≤175.00, wherein Lsa is a length of a short axis of the first housing.

18. The eyepiece optical module according to claim 12, wherein the lens element has a circumference, and a lens element glue tank is formed between the circumference and the first housing.

19. The eyepiece optical module according to claim 12, wherein the one end of the supporting cylinder is a truncated cone and further satisfies the following conditional expressions:
$$0 mm ≦ H 2 ≦ 6.68 mm ;$$
$$0.8 ≦ r 1 / r 3 ≦ 1. ; and$$
$$0.8 ≦ r 2 / r 4 ≦ 1.20 ,$$
wherein H2 is a difference between H1 and a height of the truncated cone, r2 is a radius of the other end of the supporting cylinder, r3 is a radius of curvature of a bottom portion of the guide groove, and r4 is a radius of curvature of a top portion of the guide groove.

20. The eyepiece optical module according to claim 12, wherein a depth of the guide groove is greater than or equal to 0.005 mm.
